(19) United States
(12) Patent Application Publication
(10) Pub. No.: US 2015/0067545 A1
(43) Pub. Date: Mar. 5, 2015

(54) SYSTEM AND METHOD FOR A VISUAL MEETING PATH

(71) Applicant: Cisco Technology, Inc., San Jose, CA (US)

(72) Inventor: Keith Griffin, Oranmore Co. Galway (IE)

(73) Assignee: CISCO TECHNOLOGY, INC., San Jose, CA (US)

(21) Appl. No.: 14/011,256

(22) Filed: Aug. 27, 2013

(51) Int. Cl. G06Q 10/10

(52) U.S. Cl. CPC G06Q 10/1095
USPC 715/758

(57) ABSTRACT

An example method is provided and includes causing display of a visual representation of calendar information that comprises at least one meeting indicator, determining a visual meeting path that comprises at least one visual meeting path node that corresponds to the meeting indicator, determining an attendance status of the meeting, such that the attendance status corresponds with the visual meeting path node, and causing communication of the attendance status of the meeting to an organizer of the meeting.

### TECHNICAL FIELD

This disclosure relates in general to the field of communications and, more particularly, to a visual meeting path.

### BACKGROUND

As electronic apparatuses have expanded their capabilities, as well as the number and types of operations they perform, interaction has become increasingly complex and time consuming. For example, apparatus interaction may be prone to errors, confusion, and delay. Under such circumstances, it may be desirable for a user to be able to interact with the electronic apparatus in a simple, quick, and intuitive manner. Furthermore, as users have become increasingly reliant upon their electronic apparatuses throughout their lives, many users have become reliant on utilization of a calendar program for managing their schedule. For example, many users rely on calendar programs to remind them of various events throughout the day, such as meetings, appointments, phone calls, tasks, and/or the like. Under such circumstances, it may be desirable for a user to be able to interact with the calendar program in a simple, quick, and intuitive manner.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified schematic diagram of a communication system for managing a conversation in accordance with at least one example embodiment;

FIG. 2 is a simplified schematic diagram illustrating possible details related to an example infrastructure of a communication system in accordance with at least one example embodiment;

FIGS. 3A-3C are illustrations relating to components associated with a visual meeting path according to at least one example embodiment;

FIGS. 4A-4B are illustrations relating to visual representation of calendar information according to at least one example embodiment;

FIG. 5 is an illustration relating to a visual meeting path according to at least one example embodiment;

FIGS. 6A-6B are illustrations relating to input indicative of, at least part of, a visual meeting path according to at least one example embodiment;

FIG. 7 is an illustration relating to a visual representation of meeting invitee attendance status according to at least one example embodiment;

FIG. 8 is a flow diagram illustrating activities associated with a visual meeting path according to at least one example embodiment;

FIG. 9 is a flow diagram illustrating activities associated with a visual meeting path according to at least one example embodiment;

FIG. 10 is a flow diagram illustrating activities associated with a visual meeting path according to at least one example embodiment;

FIG. 11 is a flow diagram illustrating activities associated with a visual meeting path according to at least one example embodiment;

FIG. 12 is a flow diagram illustrating activities associated with a visual meeting path according to at least one example embodiment;

FIG. 13 is a flow diagram illustrating activities associated with a visual meeting path according to at least one example embodiment; and

FIG. 14 is a flow diagram illustrating activities associated with visual representation of meeting invitee attendance status according to at least one example embodiment.

### DETAILED DESCRIPTION OF EXAMPLE EMBODIMENTS

### Overview

One or more embodiments may provide an apparatus, a method, a computer readable medium, a non-transitory computer readable medium, a computer program product, and/or the like, to cause display of a visual representation of calendar information that comprises at least one meeting indicator, the meeting indicator being positioned at a location that corresponds to a time of a meeting represented by the meeting indicator and being sized to correspond with a duration of the meeting, determine a visual meeting path that comprises at least one visual meeting path node that corresponds to the meeting indicator, and at least one visual meeting path connector that visually connects to the visual meeting path node, determine an attendance status of the meeting, such that the attendance status corresponds with the visual meeting path node, and cause communication of the attendance status of the meeting to an organizer of the meeting.

### Example Embodiments

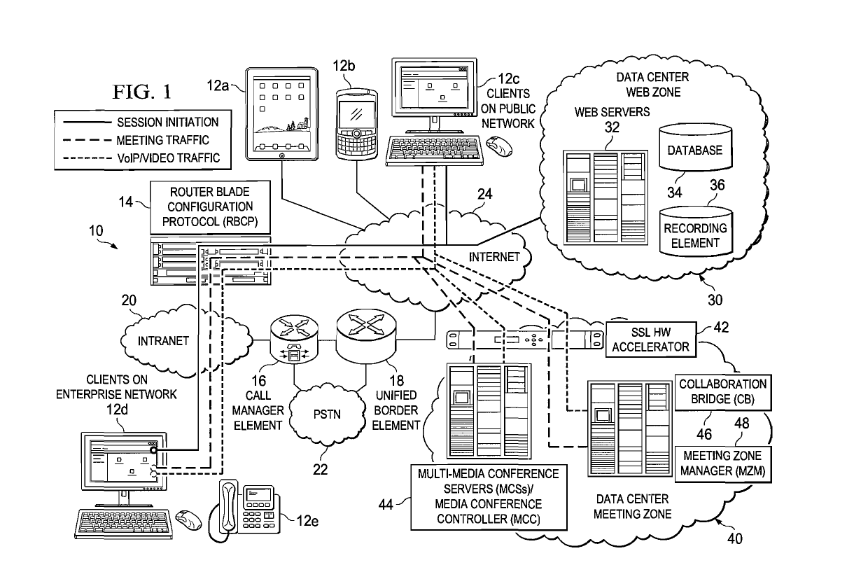

FIG. 1 is a simplified schematic diagram of a communication system 10 for managing a conversation in accordance with at least one example embodiment. Even though communication system 10 is characterized as a system for communication, other terminology may relate to communication system 10, such as a collaboration system, a virtual meeting system, a collaboration suite, and/or the like. Communication system 10 may include a number of endpoints 12a-e that may achieve suitable network connectivity via various points of attachment. In the example of FIG. 1, communication system 10 includes an Intranet 20, a public switched telephone network (PSTN) 22, and an Internet 24, which (in this particular example) offers a pathway to a data center web zone 30 and a data center meeting zone 40.

Data center web zone 30 includes a plurality of web servers 32, a database 34, and a recording element 36. Data center meeting zone 40 includes a secure sockets layer hardware (SSL HW) accelerator 42, a plurality of multimedia conference servers (MCSs)/media conference controller (MCC) 44, a collaboration bridge 46, and a meeting zone manager 48. In at least one example embodiment, each MCS may be configured to coordinate video and voice traffic for a given online meeting. Additionally, each MCC may be configured to manage the MCS from data center meeting zone 40.

Various types of routers and switches may be used to facilitate communications amongst any of the elements of FIG. 1. For example, a call manager element 16 and a unified border element 18 may be provisioned between PSTN 22 and Intranet 20. Also depicted in FIG. 1 are a number of pathways (e.g., shown as solid or broken lines) between the elements for propagating meeting traffic, session initiation, and voice over Internet protocol (VoIP)/video traffic.

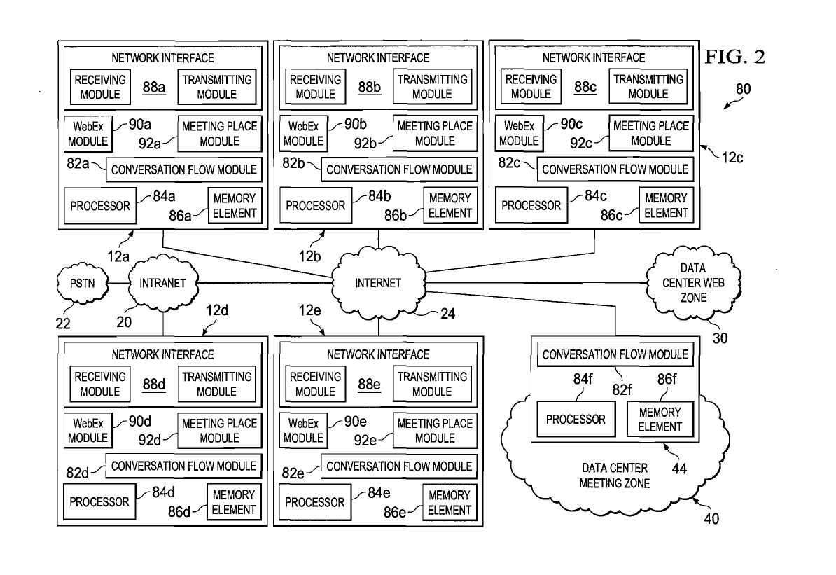

FIG. 2 is a simplified schematic diagram illustrating possible details related to an example infrastructure of a communication system 10 in accordance with at least one example embodiment. Each of endpoints 12a-e are provisioned with a respective conversation flow module 82a-e, a respective processor 84a-e, a respective memory element 86a-e, a respective WebEx module 90a-e, a respective Meeting Place module 92a-e, and a respective network interface 88a-e, which includes a respective receiving module and a respective transmitting module for exchanging data (e.g., for exchanging packets in a network environment). FIG. 2 illustrates an example implementation of MCSs/MCC 44 that is similarly provisioned with a conversation flow module 82f, a processor 84f, and a memory element 86f.

In at least one example embodiment, each endpoint 12a-e and/or MCSs/MCC 44 includes software (e.g., as part of conversation flow modules 82a-f) to achieve or to support managing a conversation, as outlined herein in this document. In other embodiments, this feature may be provided externally to any of the aforementioned elements, or included in some other network element to achieve this functionality. Alternatively, several elements may include software (or reciprocating software) that may coordinate in order to achieve the operations, as outlined herein. In still other embodiments, any of the devices of the FIGURES may include any suitable algorithms, hardware, software, components, modules, interfaces, or objects that facilitate in managing a conversation.

It is imperative to note that FIG. 2 is indicative of just one, of the multitude, of example implementations of communication system 10. Any of the modules or elements within endpoints 12a-e and/or MCSs/MCC 44 may readily be replaced, substituted, or eliminated based on particular needs. Furthermore, although described with reference to particular scenarios, where a given module (e.g., WebEx module 90a-e, Meeting Place module 92a-e, conversation flow module 82a-e, etc.) is provided within endpoints 12a-e or MCSs/MCC 44, any one or more of these elements may be provided externally, or consolidated and/or combined in any suitable fashion. In certain instances, certain elements may be provided in a single proprietary module, device, unit, etc. in order to achieve the teachings of the present disclosure.

Endpoints 12a-e are representative of any type of client or user wishing to participate in a meeting session in communication system 10 (e.g., or in any other online platform). Furthermore, endpoints 12a-e may be associated with individuals, clients, customers, or end users wishing to participate in a meeting session in communication system 10 via some network. The term ‘endpoint’ is inclusive of devices used to initiate a communication, such as a computer, a personal digital assistant (PDA), a laptop or electronic notebook, a cellular telephone of any kind, an iPhone, an IP phone, a Blackberry, a Google Droid, an iPad, a tablet, or any other device, component, element, or object capable of initiating voice, audio, video, media, or data exchanges within communication system 10. Endpoints 12a-e may also be inclusive of a suitable interface to the human user, such as a microphone, a display, or a keyboard or other terminal equipment. Endpoints 12a-e may also be any device that seeks to initiate a communication on behalf of another entity or element, such as a program, a proprietary conferencing device, a database, or any other component, device, element, or object capable of initiating an exchange within communication system 10. Data, as used herein in this document, refers to any type of numeric, voice, video, media, or script data, or any type of source or object code, or any other suitable information in any appropriate format that may be communicated from one point to another.

MCSs/MCC 44 and web servers 32 are network elements that manage (or that cooperate with each other in order to manage) aspects of a meeting session. As used herein in this Specification, the term ‘network element’ is meant to encompass any type of servers (e.g., a video server, a web server, etc.), routers, switches, gateways, bridges, loadbalancers, firewalls, inline service nodes, proxies, network appliances, processors, modules, or any other suitable device, component, element, or object operable to exchange information in a network environment. This network element may include any suitable hardware, software, components, modules, interfaces, or objects that facilitate the operations thereof. This may be inclusive of appropriate algorithms and communication protocols that allow for the effective exchange (reception and/or transmission) of data or information. In one particular example, MCSs/MCC 44 and web servers 32 are servers that may interact with each other via the networks of FIG. 1.

Intranet 20, PSTN 22, and Internet 24 represent a series of points or nodes of interconnected communication paths for receiving and transmitting packets of information that propagate through communication system 10. These networks may offer connectivity to any of the devices or endpoints of FIG. 1. Moreover, Intranet 20, PSTN 22, and Internet 24 offer a communicative interface between sites (and/or participants, rooms, etc.) and may be any local area network (LAN), wireless LAN (WLAN), metropolitan area network (MAN), wide area network (WAN), extranet, Intranet, virtual private network (VPN), virtual LAN (VLAN), or any other appropriate architecture or system that facilitates communications in a network environment.

Intranet 20, PSTN 22, and Internet 24 may support a transmission control protocol (TCP)/IP, or a user datagram protocol (UDP)/IP in particular embodiments of the present disclosure; however, Intranet 20, PSTN 22, and Internet 24 may alternatively implement any other suitable communication protocol for transmitting and receiving data packets within communication system 10. Note also that Intranet 20, PSTN 22, and Internet 24 may accommodate any number of ancillary activities, which may accompany a meeting session. This network connectivity may facilitate all informational exchanges (e.g., notes, virtual whiteboards, PowerPoint presentations, e-mailing, word-processing applications, etc.). Along similar reasoning, Intranet 20, PSTN 22, and Internet 24 may foster all such communications and, further, be replaced by any suitable network components for facilitating the propagation of data between participants in a conferencing session.

It should also be noted that endpoints 12a-e and MCSs/MCC 44 may share (or coordinate) certain processing operations. Using a similar rationale, their respective memory elements may store, maintain, and/or update data in any number of possible manners. Additionally, any of the illustrated memory elements or processors may be removed, or otherwise consolidated such that a single processor and a single memory location is responsible for certain activities associated with managing a conversation. In a general sense, the arrangement depicted in FIG. 2 may be more logical in its representations, whereas a physical architecture may include various permutations/combinations/hybrids of these elements.

Note that in certain example embodiments, the conversation management functions outlined herein may be implemented by logic encoded in one or more tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory element may store data used for the operations described herein. This includes the memory element being able to store software, logic, code, or processor instructions that may be executed to carry out the activities described in this Specification. A processor may execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, conversation flow modules 82a-f include software in order to achieve the conversation management functions outlined herein. These activities may be facilitated by MCSs/MCC 44 and/or the various endpoints 12a-f. MCSs/MCC 44 and/or endpoints 12a-f may include memory elements for storing information to be used in managing a conversation, as outlined herein. Additionally, MCSs/MCC 44 and/or endpoints 12a-f may include a processor that may execute software or an algorithm to perform management of a conversation, as discussed in this Specification. These devices may further keep information in any suitable memory element (random access memory (RAM), ROM, EPROM, EEPROM, ASIC, etc.), software, hardware, or in any other suitable component, device, element, or object where appropriate and based on particular needs. Any possible memory items (e.g., database, table, cache, etc.) should be construed as being encompassed within the broad term ‘memory element.’ Similarly, any of the potential processing elements, modules, and machines described in this Specification should be construed as being encompassed within the broad term ‘processor.’

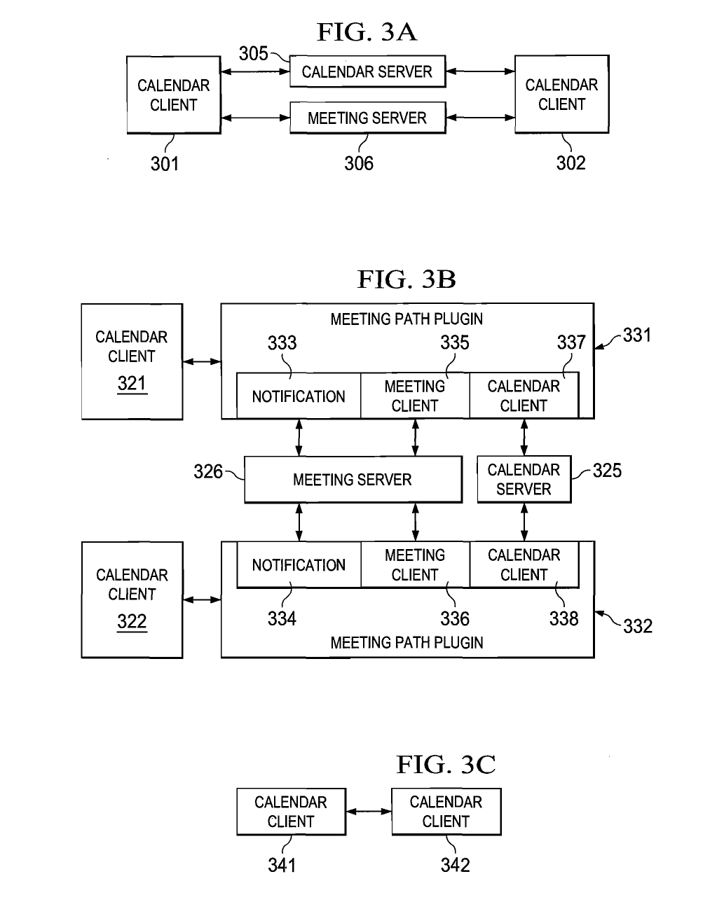

FIGS. 3A-3C are illustrations relating to components associated with a visual meeting path according to at least one example embodiment. The examples of FIGURES are merely examples and do not limit the claims in any way. For example, components may vary, number of components may vary, interaction between components may vary, and/or the like.

There are many different types of component arrangements that may allow a user to utilize a calendar program. For example, the calendar program may relate to a calendar client program that allows the user to interact with calendar information. For example, the user may be able to send meeting information to other users, to respond to meeting information from other users, to view information associated with scheduled meetings, and/or the like. In many circumstances, the meeting client may communicate, directly and/or indirectly, with other meeting client programs associated with other users. There may be various topologies that allow such communication to occur. Therefore, the examples included herein describe functionality that may be attributable to a system that utilizes a visual meeting path, but the partitioning of such functionality to any particular component or set of components may vary across different implementations and/or different circumstances. For example, in an implementation, a particular functionality may be performed by a component, and in a different implementation, the same functionality may be performed by a different component. In this manner, even though a component, such as a calendar client program, may be described as a single component, in some example embodiments, such a component may comprise a plurality of sub-components that may be allocated to a single apparatus or a plurality of apparatuses. In this manner, a component described herein may span multiple apparatuses, such as a user apparatus, a cloud-based apparatus, an apparatus within a network, and/or the like.

In at least one example embodiment, a calendar client program relates to a program that provides calendar information to a user, allows a user to interact with calendar information, and/or the like. A calendar client program may be a program that is accessible by a user. For example, the client program may be executed on an apparatus with which the user is directly interacting or an apparatus with which the user is indirectly interacting. For example, the client program may be executed on a desktop computer, a laptop computer, a tablet, a mobile phone, and/or the like. In another example, the user may be interacting with an apparatus, and the client program may be executed on a different apparatus. For example, the user may be interacting with a peripheral apparatus, such as a wearable device, and the client program may be executed on an apparatus with which the peripheral device is in, at least indirect, communication. In another example, the client program may be executed on a cloud accessible apparatus, and the user may be interacting with a separate apparatus that is in communication with the cloud accessible apparatus. In such an example, the user may be interacting with an internet browser program that is in communication with a calendar client program that is being executed on a different apparatus, such as a cloud-based apparatus. In at least one example embodiment, calendar information includes information indicative of one or more meetings. A meeting may relate to any calendar information that relates to at least one other user. A meeting may relate to an event that has a start time and an end time such that the event may be attended at a time between the start time and the end time. For example, a meeting may relate to an appointment that a user has with another user, a date that the user has with the user's spouse, a business meeting that the user has with a colleague, and/or the like. In some circumstances, the user may be an organizer of the meeting or a different user may be the organizer of the meeting. In at least one example embodiment, an organizer of a meeting relates to a user that establishes the meeting, sends information regarding the meeting to other users, controls scheduling of the meeting, and/or the like. For example, the organizer of the meeting may send one or more invitations to the meeting to one or more other users. In such an example, a user who receives an invitation to the meeting may be referred to as a meeting invitee. For example, the meeting organizer may designate one or more meeting invitees to attend the meeting.

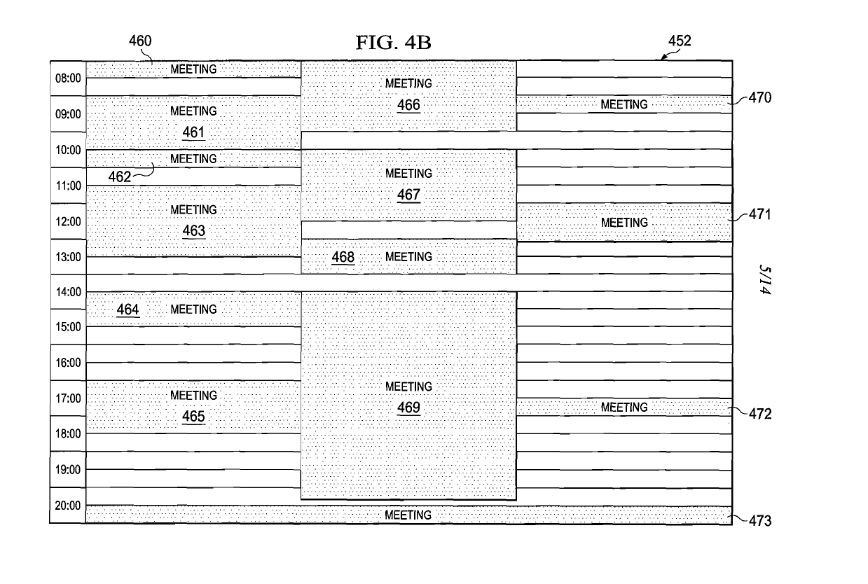

In some circumstances, it may be desirable for the organizer of the meeting to be able to receive information indicating attendance status of one or more meeting invitees. For example, the organizer of the meeting may desire to receive information indicating whether a meeting invitee will attend the meeting, when a meeting invitee will attend the meeting, and/or the like. In at least one example embodiment, attendance status of a meeting may be similar as described regarding FIG. 5.

In at least one example embodiment, the calendar client program of a meeting invitee causes communication of the attendance status of the meeting to an organizer of the meeting. In such an example, the calendar client program of a meeting invitee may cause communication of the attendance status of the meeting to a calendar client program associated with the organizer of the meeting. In at least one example embodiment, causation of communication from a calendar client program relates to communicating the attendance status to another calendar client program, to a server, to a plugin, and/or the like. In at least one example embodiment, causation of communication of the attendance status comprises sending information indicative of the attendance status to a calendar client program. For example, the information indicative of the attendance status may relate to a data structure, a message, a function call, and/or the like that conveys the attendance status.

In some circumstances, meeting status information may change. For example, a meeting invitee may elect to attend a meeting, and later elect to avoid attendance of the meeting. In such an example, the calendar client program of the meeting invitee may cause communication of an attendance status indicating attendance of the meeting, and may later cause communication of an attendance status indicating non-attendance of the meeting.

In some circumstances, there may be a plurality of meeting invitees associated with a meeting. In such an example, the organizer of the meeting may receive attendance status associated with a plurality of meeting invitees. For example, the calendar client program of the organizer of the meeting may receive information indicative of an attendance status associated with a meeting invitee, and receive information indicative of a different attendance status associated with a different meeting invitee.

In at least one example embodiment, there may be multiple meetings. For example, an organizer of a meeting may cause communication of a meeting to a meeting invitee, and may cause communication of a different meeting to another meeting invitee. Similarly, a user may receive information indicative of a meeting from a meeting organizer, and receive information indicative of a different meeting from another meeting organizer.

In some circumstances, a calendar client program may allow a user to be an organizer of a meeting and a meeting invitee of a different meeting. In this manner, there may be circumstances where a calendar client program causes communication of information indicative of a meeting, and other circumstances where the same calendar client program causes communication of attendance status of a different meeting.

In some circumstances, a calendar client program may allow a user to interact with a meeting service. The meeting service may be similar as described regarding FIGS. 1-2. In such an example, the calendar client may cause communication of attendance information to a meeting server associated with the meeting service.

FIG. 3A is an illustration relating to components associated with a visual meeting path according to at least one example embodiment. In the example of FIG. 3A, calendar clients 301 and 302 are in communication with calendar server 305 and meeting server 306. Even though the example of FIG. 3A illustrates two calendar client programs, the number of calendar client programs in communication with calendar server 305 and/or meeting server 306 may differ, may vary over time, and/or the like.

In the example of FIG. 3A, calendar client program 301 may relate to a calendar client program associated with an organizer of a meeting and calendar client program 302 may relate to a calendar client program associated with a meeting invitee. In such an example, calendar client program 301 may cause communication of meeting information by sending information indicative of the meeting to calendar server 305 and/or meeting server 306. In such an example, calendar client program 302 may receive the information indicative of the meeting from calendar server 305 and/or meeting server 306. Similarly, calendar client program 302 may cause communication of attendance status by sending information indicative of the attendance status to calendar server 305 and/or meeting server 306. In such an example, calendar client program 301 may receive the information indicative of the attendance status from calendar server 305 and/or meeting server 306.

FIG. 3B is an illustration relating to components associated with a visual meeting path according to at least one example embodiment. In some circumstances, there may be a plugin program that performs calendar related operations for a calendar client program. In the example of FIG. 3B, calendar client 321 is in communication with calendar server 325 and meeting server 326 by way of meeting path plugin program 331, and calendar client 322 is in communication with calendar server 325 and meeting server 326 by way of meeting path plugin program 332. Even though the example of FIG. 3B illustrates two meeting path plugin programs, the number of meeting path plugin programs in communication with calendar server 325 and/or meeting server 326 may differ, may vary over time, and/or the like. Even though the example of FIG. 3B illustrates meeting path plugin program 331 as being separate from calendar client program 321, and illustrates meeting path plugin program 332 as being separate from calendar client program 322, in at least one example embodiment, calendar client program 321 comprises meeting path plugin program 331, and calendar client program 322 comprises meeting path plugin program 332.

In the example of FIG. 3B, meeting path plugin program 331 comprises notification component 333, meeting client 335, and calendar client component 337. In the example of FIG. 3B, meeting path plugin program 332 comprises notification component 334, meeting client 336, and calendar client component 338. A notification component may relate to a component that manages notifications from a meeting server, such as notifications associated with a meeting start, a meeting session, and/or the like. A meeting client component may relate to a component that manages communication with a meeting server, such as information associated with establishment of a meeting session, scheduling of a meeting session, modification of a meeting session, joining a meeting session, and/or the like. A calendar client component may relate to a component that manages communication with a calendar server, such as sending a meeting invitation, receiving attendance status associated with a meeting, sending attendance status associated with a meeting, and/or the like.

In the example of FIG. 3B, meeting path plugin program 331 may relate to a meeting path plugin program associated with an organizer of a meeting and meeting path plugin program 332 may relate to a meeting path plugin program associated with a meeting invitee. In such an example, meeting path plugin program 331 may cause communication of meeting information by sending information indicative of the meeting to calendar server 325 by way of calendar client component 337, and/or to meeting server 326 by way of meeting client component 335. In such an example, meeting path plugin program 332 may receive the information indicative of the meeting from calendar server 325 by way of calendar client component 338, and/or from meeting server 326 by way of meeting client component 336. Similarly, meeting path plugin program 332 may cause communication of attendance status by sending information indicative of the attendance status to calendar server 325 by way of calendar client component 338, and/or to meeting server 326 by way of meeting client component 336. In such an example, meeting path plugin program 331 may receive the information indicative of the attendance status from calendar server 325 by way of calendar client component 337, and/or from meeting server 326 by way of meeting client component 335.

FIG. 3C is an illustration relating to components associated with a visual meeting path according to at least one example embodiment. In the example of FIG. 3C, calendar clients 341 and 342 are in communication with each other. Even though the example of FIG. 3C illustrates two calendar client programs, the number of calendar client programs may differ, may vary over time, and/or the like.

In the example of FIG. 3A, calendar client program 341 may relate to a calendar client program associated with an organizer of a meeting and calendar client program 342 may relate to a calendar client program associated with a meeting invitee. In such an example, calendar client program 341 may cause communication of meeting information by sending information indicative of the meeting to calendar client program 342. In such an example, calendar client program 342 may receive the information indicative of the meeting from calendar client program 341. Similarly, calendar client program 342 may cause communication of attendance status by sending information indicative of the attendance status to calendar client program 341. In such an example, calendar client program 341 may receive the information indicative of the attendance status from calendar client program 342.

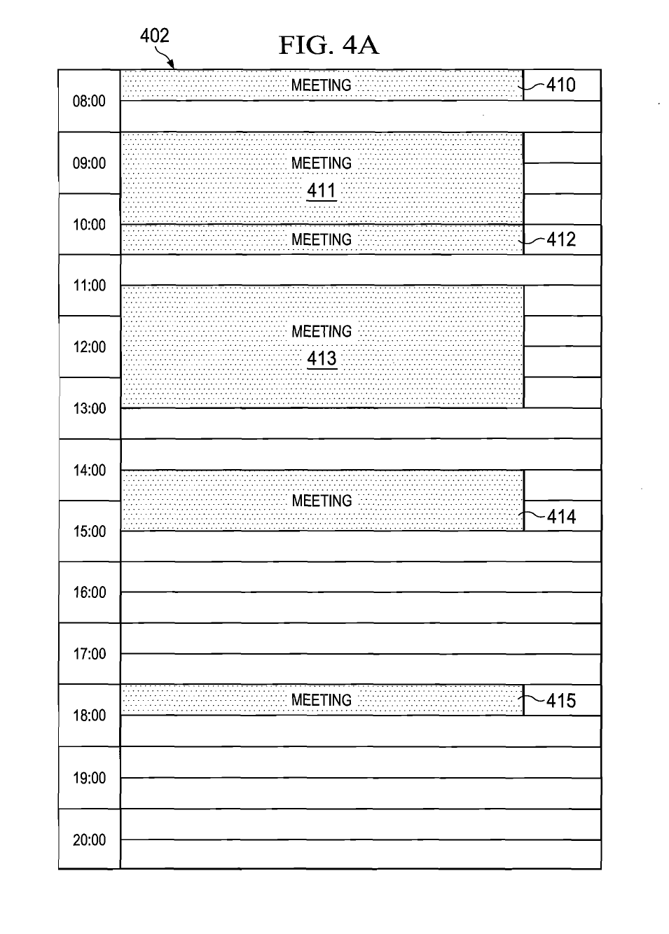

FIGS. 4A-4B are illustrations relating to visual representation of calendar information according to at least one example embodiment. The examples of FIGS. 4A-4B are merely examples and do not limit the claims in any way. For example, orientation of visual information may vary, representation of information may vary, the format may vary, arrangement of information may vary, and/or the like.

In many circumstances, a user may benefit from a visual representation of calendar information. For example, the user may desire to perceive a graphical representation of a meeting, interrelationship between meetings, duration of a meeting a start time of a meeting, an end time of a meeting, and/or the like. In at least one example embodiment, an apparatus causes display of a visual representation of calendar information. Causation of display may relate to displaying information, sending information to an external apparatus to display the information, and/or the like.

In at least one example embodiment, the visual representation of the calendar information is arranged on an axis that indicates time. For example, a vertical axis may denote variation in time, a horizontal axis may denote variation in time, and/or the like.

In at least one example embodiment, the visual representation of calendar information comprises at least one meeting indicator. In at least one example embodiment, a meeting indicator relates to a visual representation of at least one aspect of a meeting. An aspect of a meeting may relate to a time of the meeting, a duration of the meeting, identity of a meeting organizer, a title of a meeting, etc. In at least one example embodiment, the meeting indicator is positioned at a location that corresponds to a time of a meeting represented by the meeting indicator. For example, at least part of the meeting indicator may correspond with a position that denotes a time of the meeting. In at least one example embodiment, the meeting indicator is sized to correspond with a duration of the meeting. For example, a boundary of the meeting indicator may be positioned in correspondence with a start time of the meeting, and an opposite boundary of the meeting indicator may be positioned in correspondence with an end time of the meeting.

FIG. 4A is an illustration relating to visual representation 402 of calendar information according to at least one example embodiment. It can be seen that visual representation 402 of calendar information is arranged on a vertical axis that indicates time. It can be seen that visual representation 402 comprises meeting indicators 410, 411, 412, 413, 414, and 415.

Meeting indicator 410 relates to a meeting that has a start time of 8:00 and an end time of 8:30. It can be seen that the top boundary of meeting indicator 410 corresponds with a time of 8:00 and that the bottom boundary of meeting indicator 410 corresponds with a time of 8:30. In this manner, meeting indicator 410 is sized to indicate a duration of 30 minutes.

Meeting indicator 411 relates to a meeting that has a start time of 9:00 and an end time of 10:30. It can be seen that the top boundary of meeting indicator 411 corresponds with a time of 9:00 and that the bottom boundary of meeting indicator 411 corresponds with a time of 10:30. In this manner, meeting indicator 411 is sized to indicate a duration of 1 hour and 30 minutes.

Meeting indicator 412 relates to a meeting that has a start time of 10:30 and an end time of 11:00. It can be seen that the top boundary of meeting indicator 412 corresponds with a time of 10:30 and that the bottom boundary of meeting indicator 412 corresponds with a time of 11:00. In this manner, meeting indicator 412 is sized to indicate a duration of 30 minutes.

Meeting indicator 413 relates to a meeting that has a start time of 11:30 and an end time of 13:30. It can be seen that the top boundary of meeting indicator 413 corresponds with a time of 11:30 and that the bottom boundary of meeting indicator 413 corresponds with a time of 13:30. In this manner, meeting indicator 413 is sized to indicate a duration of 2 hours.

Meeting indicator 414 relates to a meeting that has a start time of 14:30 and an end time of 15:30. It can be seen that the top boundary of meeting indicator 414 corresponds with a time of 14:30 and that the bottom boundary of meeting indicator 414 corresponds with a time of 15:30. In this manner, meeting indicator 414 is sized to indicate a duration of 1 hour.

Meeting indicator 415 relates to a meeting that has a start time of 18:00 and an end time of 18:30. It can be seen that the top boundary of meeting indicator 415 corresponds with a time of 18:00 and that the bottom boundary of meeting indicator 415 corresponds with a time of 18:30. In this manner, meeting indicator 415 is sized to indicate a duration of 30 minutes.

FIG. 4B is an illustration relating to visual representation 452 of calendar information according to at least one example embodiment. In some circumstances, a user may have multiple meetings that correspond with the same time. For example, a meeting may chronologically overlap with another meeting. In such circumstances, the visual representation of the calendar information may represent meetings that correspond to at least one same time along a different axis than the axis indicative of time. For example, a visual representation of calendar information may arrange meeting indicators along a vertical axis indicative of time and along a horizontal axis indicative of chronologically corresponding meeting indicators. It can be seen that visual representation 452 of calendar information is arranged on a vertical axis that indicates time. It can be seen that visual representation 452 comprises meeting indicators 460, 461, 462, 463, 464, 465, 466, 467, 468, 569, 470, 471, 472, and 473.

Meeting indicator 460 relates to a meeting that has a start time of 8:00 and an end time of 8:30. It can be seen that the top boundary of meeting indicator 460 corresponds with a time of 8:00 and that the bottom boundary of meeting indicator 460 corresponds with a time of 8:30. In this manner, meeting indicator 460 is sized to indicate a duration of 30 minutes.

Meeting indicator 461 relates to a meeting that has a start time of 9:00 and an end time of 10:30. It can be seen that the top boundary of meeting indicator 461 corresponds with a time of 9:00 and that the bottom boundary of meeting indicator 461 corresponds with a time of 10:30. In this manner, meeting indicator 461 is sized to indicate a duration of 1 hour and 30 minutes.

Meeting indicator 462 relates to a meeting that has a start time of 10:30 and an end time of 11:00. It can be seen that the top boundary of meeting indicator 462 corresponds with a time of 10:30 and that the bottom boundary of meeting indicator 462 corresponds with a time of 11:00. In this manner, meeting indicator 462 is sized to indicate a duration of 30 minutes.

Meeting indicator 463 relates to a meeting that has a start time of 11:30 and an end time of 13:30. It can be seen that the top boundary of meeting indicator 463 corresponds with a time of 11:30 and that the bottom boundary of meeting indicator 463 corresponds with a time of 13:30. In this manner, meeting indicator 463 is sized to indicate a duration of 2 hours.

Meeting indicator 464 relates to a meeting that has a start time of 14:30 and an end time of 15:30. It can be seen that the top boundary of meeting indicator 464 corresponds with a time of 14:30 and that the bottom boundary of meeting indicator 464 corresponds with a time of 15:30. In this manner, meeting indicator 464 is sized to indicate a duration of 1 hour.

Meeting indicator 465 relates to a meeting that has a start time of 17:00 and an end time of 18:30. It can be seen that the top boundary of meeting indicator 465 corresponds with a time of 17:00 and that the bottom boundary of meeting indicator 465 corresponds with a time of 18:30. In this manner, meeting indicator 465 is sized to indicate a duration of 1 hour and 30 minutes.

Meeting indicator 466 relates to a meeting that has a start time of 8:00 and an end time of 10:00. It can be seen that the top boundary of meeting indicator 466 corresponds with a time of 8:00 and that the bottom boundary of meeting indicator 466 corresponds with a time of 10:00. In this manner, meeting indicator 466 is sized to indicate a duration of 2 hours. It can be seen that, at least part of, meeting indicator 466 corresponds with, at least part of, a time of meeting indicator 460 and, at least part of, a time of meeting indicator 461.

Meeting indicator 467 relates to a meeting that has a start time of 10:30 and an end time of 12:30. It can be seen that the top boundary of meeting indicator 467 corresponds with a time of 10:30 and that the bottom boundary of meeting indicator 467 corresponds with a time of 12:30. In this manner, meeting indicator 467 is sized to indicate a duration of 2 hours. It can be seen that, at least part of, meeting indicator 467 corresponds with, at least part of, a time of meeting indicator 462 and, at least part of, a time of meeting indicator 463.

Meeting indicator 468 relates to a meeting that has a start time of 13:00 and an end time of 14:00. It can be seen that the top boundary of meeting indicator 468 corresponds with a time of 13:00 and that the bottom boundary of meeting indicator 468 corresponds with a time of 14:00. In this manner, meeting indicator 468 is sized to indicate a duration of 1 hour. It can be seen that, at least part of, meeting indicator 468 corresponds with, at least part of, a time of meeting indicator 463.

Meeting indicator 469 relates to a meeting that has a start time of 14:30 and an end time of 20:15. It can be seen that the top boundary of meeting indicator 469 corresponds with a time of 14:30 and that the bottom boundary of meeting indicator 469 corresponds with a time of 20:15. In this manner, meeting indicator 469 is sized to indicate a duration of 5 hours and 45 minutes.

Meeting indicator 470 relates to a meeting that has a start time of 9:00 and an end time of 9:30. It can be seen that the top boundary of meeting indicator 470 corresponds with a time of 9:00 and that the bottom boundary of meeting indicator 470 corresponds with a time of 9:30. In this manner, meeting indicator 470 is sized to indicate a duration of 30 minutes. It can be seen that, at least part of, meeting indicator 470 corresponds with, at least part of, a time of meeting indicator 461 and, at least part of, a time of meeting indicator 466.

Meeting indicator 471 relates to a meeting that has a start time of 12:00 and an end time of 13:05. It can be seen that the top boundary of meeting indicator 471 corresponds with a time of 12:00 and that the bottom boundary of meeting indicator 471 corresponds with a time of 13:05. In this manner, meeting indicator 471 is sized to indicate a duration of 1 hour and 5 minutes. It can be seen that, at least part of, meeting indicator 471 corresponds with, at least part of, a time of meeting indicator 463, at least part of, a time of meeting indicator 467, and, at least part of, a time of meeting indicator 468.

Meeting indicator 472 relates to a meeting that has a start time of 17:30 and an end time of 18:00. It can be seen that the top boundary of meeting indicator 472 corresponds with a time of 17:30 and that the bottom boundary of meeting indicator 472 corresponds with a time of 18:00. In this manner, meeting indicator 472 is sized to indicate a duration of 30 minutes. It can be seen that, at least part of, meeting indicator 472 corresponds with, at least part of, a time of meeting indicator 465 and, at least part of, a time of meeting indicator 469.

Meeting indicator 473 relates to a meeting that has a start time of 20:30 and an end time of 21:00. It can be seen that the top boundary of meeting indicator 473 corresponds with a time of 20:30 and that the bottom boundary of meeting indicator 473 corresponds with a time of 21:00. In this manner, meeting indicator 473 is sized to indicate a duration of 30 minutes. It can be seen that, at least part of, meeting indicator 473 fails to correspond with, at least part of, a time of any other meeting indicator.

FIG. 5 is an illustration relating to a visual meeting path according to at least one example embodiment. The example of FIG. 5 is merely an example and does not limit the claims in any way. For example, orientation of visual information may vary, representation of information may vary, the format may vary, arrangement of information may vary, and/or the like.

Calendar management can often be complex for a busy professional. Even when calendar management is delegated to an administrative professional it may be difficult to get away from multiple clashing events and it may often be necessary to have multiple events occurring at the same time in the calendar e.g. for informational purposes or as a backup should another more critical meeting move. This can be seen in the example of FIG. 4B. Another common occurrence is meetings that partially overlap where an attendee might miss the beginning of a meeting but wish to keep it on calendar to attend a later portion of the meeting. For example, a user may desire to attend a part of a meeting and a part of a different chronologically overlapping meeting. It is also common practice to accept meeting invitations in advance of meetings but review your schedule a shorter time ahead of the meeting e.g. on the day.

It may be desirable to provide an apparatus that allows simple and intuitive ways to interact with complex calendar information. In addition, it may be desirable to provide an apparatus that allows for a simple and intuitive manner in which a user may provide attendance status information for one or more meetings. Furthermore, it may be desirable to provide an apparatus that allows a user to visually determine attendance status of a plurality of meetings associated with calendar information in a simple and intuitive manner.

In at least one example embodiment, an attendance status may relate to attendance of an entirety of a meeting or attendance of less than the entirety of the meeting. For example, an attendance status may comprise at least one attendance start time, at least one attendance end time, and/or the like. For example, the attendance status may indicate attendance of the entirety of a meeting by comprising an attendance start time that corresponds with the meeting start time and an attendance end time that corresponds with the meeting end time. In at least one example embodiment, the attendance status may indicate less than the entirety of the meeting by way of comprising an attendance start time after the meeting start time, an attendance end time before the meeting end time, and/or the like. In at least one example embodiment, an attendance status comprises a plurality of attendance start times, a plurality of attendance end times, and/or the like. For example, a meeting participant may join a meeting, leave a meeting, and subsequently rejoin the meeting. In such circumstances, the attendance status may comprise an attendance start time that corresponds with a time in which the meeting participant will join the meeting, an attendance end time that corresponds with a time in which the meeting participant will leave the meeting, and another attendance start time that corresponds with a time in which the meeting participant will rejoin the meeting.

In at least one example embodiment, a user may interact with calendar information by way of a visual meeting path. In at least one example embodiment, a visual meeting path relates to a graphical representation of a user's attendance status in relation to calendar information. For example, if the calendar information relates to a plurality of meetings, the visual meeting path may be a graphical representation of the user's attendance status for the plurality of meetings. In at least one example embodiment, the visual meeting path relates to a linear representation of attendance status associated with one or more meetings, such that attendance status is represented by way of position of, at least part of, the visual meeting path in relation to a meeting indicator associated with the meeting. In at least one example embodiment, a visual meeting path comprises a plurality of visual meeting path nodes and one or more visual meeting path connectors. The visual meeting path connector may visually connect a visual meeting path node to another visual meeting path node. For example, the visual meeting path connector may provide a visual indication between chronologically adjacent visual meeting path nodes. Chronologically adjacent may relate to two visual meeting path nodes being positioned along a visual meeting path absent any intervening visual meeting path node. For example, a first visual meeting path node associated with a first time, may be chronologically adjacent to a second visual meeting path node associated with a second time, in circumstances where there is an absence of a third visual meeting path node that is associated with a time between the first time and the second time.

In at least one example embodiment, a visual meeting path comprises at least one visual meeting path node that corresponds to a meeting indicator, and at least one visual meeting path connector that visually connects to the visual meeting path node to another visual meeting path node. In at least one example embodiment, correspondence of the meeting and the visual meeting path node relates to a position of the visual meeting path node corresponding to a position that is included by the meeting indicator. For example, the visual meeting path node may be positioned with respect to a meeting indicator to identify a time associated with attendance status of the meeting associated with the meeting indicator. For example, a visual meeting path node may indicate an attendance start time, an attendance end time, and/or the like.

In at least one example embodiment, the attendance status indicates attendance of less than an entirety of the meeting. In some circumstances, the attendance start time may relate to a time after a start time of the meeting. In such circumstances, the associated visual meeting path node may be positioned to indicate the time after the start time of the meeting. In some circumstances, the attendance end time may relate to a time before an end time of the meeting. In such circumstances, the associated visual meeting path node may be positioned to indicate the time before the end time of the meeting.

In at least one example embodiment, an apparatus determines a visual meeting path. Determination of the visual meeting path may be based, at least in part, on retrieval of attendance status information associated with one or more meeting indicators, input received from a user, and/or the like. In at least one example embodiment, the apparatus determines an attendance status of the meeting, such that the attendance status corresponds with the visual meeting path node. For example, the apparatus may determine an attendance start time, an attendance end time, and/or the like.

FIG. 5 is an illustration relating to visual representation 502 of calendar information in relation to a visual meeting path according to at least one example embodiment. It can be seen that visual representation 502 of calendar information is arranged on a vertical axis that indicates time. It can be seen that visual representation 502 comprises meeting indicators 510, 511, 512, 513, 514, 515, 516, 517, 518, 569, 520, 521, 522, and 523.

Meeting indicator 510 relates to a meeting that has a start time of 8:00 and an end time of 8:30. It can be seen that the top boundary of meeting indicator 510 corresponds with a time of 8:00 and that the bottom boundary of meeting indicator 510 corresponds with a time of 8:30. In this manner, meeting indicator 510 is sized to indicate a duration of 30 minutes.

Meeting indicator 511 relates to a meeting that has a start time of 9:00 and an end time of 10:30. It can be seen that the top boundary of meeting indicator 511 corresponds with a time of 9:00 and that the bottom boundary of meeting indicator 511 corresponds with a time of 10:30. In this manner, meeting indicator 511 is sized to indicate a duration of 1 hour and 30 minutes.

Meeting indicator 512 relates to a meeting that has a start time of 10:30 and an end time of 11:00. It can be seen that the top boundary of meeting indicator 512 corresponds with a time of 10:30 and that the bottom boundary of meeting indicator 512 corresponds with a time of 11:00. In this manner, meeting indicator 512 is sized to indicate a duration of 30 minutes.

Meeting indicator 513 relates to a meeting that has a start time of 11:30 and an end time of 13:30. It can be seen that the top boundary of meeting indicator 513 corresponds with a time of 11:30 and that the bottom boundary of meeting indicator 513 corresponds with a time of 13:30. In this manner, meeting indicator 513 is sized to indicate a duration of 2 hours.

Meeting indicator 514 relates to a meeting that has a start time of 14:30 and an end time of 15:30. It can be seen that the top boundary of meeting indicator 514 corresponds with a time of 14:30 and that the bottom boundary of meeting indicator 514 corresponds with a time of 15:30. In this manner, meeting indicator 514 is sized to indicate a duration of 1 hour.

Meeting indicator 515 relates to a meeting that has a start time of 17:00 and an end time of 18:30. It can be seen that the top boundary of meeting indicator 515 corresponds with a time of 17:00 and that the bottom boundary of meeting indicator 515 corresponds with a time of 18:30. In this manner, meeting indicator 515 is sized to indicate a duration of 1 hour and 30 minutes.

Meeting indicator 516 relates to a meeting that has a start time of 8:00 and an end time of 10:00. It can be seen that the top boundary of meeting indicator 516 corresponds with a time of 8:00 and that the bottom boundary of meeting indicator 516 corresponds with a time of 10:00. In this manner, meeting indicator 516 is sized to indicate a duration of 2 hours. It can be seen that, at least part of, meeting indicator 516 corresponds with, at least part of, a time of meeting indicator 510 and, at least part of, a time of meeting indicator 511.

Meeting indicator 517 relates to a meeting that has a start time of 10:30 and an end time of 12:30. It can be seen that the top boundary of meeting indicator 517 corresponds with a time of 10:30 and that the bottom boundary of meeting indicator 517 corresponds with a time of 12:30. In this manner, meeting indicator 517 is sized to indicate a duration of 2 hours. It can be seen that, at least part of, meeting indicator 517 corresponds with, at least part of, a time of meeting indicator 512 and, at least part of, a time of meeting indicator 513.

Meeting indicator 518 relates to a meeting that has a start time of 13:00 and an end time of 14:00. It can be seen that the top boundary of meeting indicator 518 corresponds with a time of 13:00 and that the bottom boundary of meeting indicator 518 corresponds with a time of 14:00. In this manner, meeting indicator 518 is sized to indicate a duration of 1 hour. It can be seen that, at least part of, meeting indicator 518 corresponds with, at least part of, a time of meeting indicator 513.

Meeting indicator 519 relates to a meeting that has a start time of 14:30 and an end time of 20:15. It can be seen that the top boundary of meeting indicator 519 corresponds with a time of 14:30 and that the bottom boundary of meeting indicator 519 corresponds with a time of 20:15. In this manner, meeting indicator 519 is sized to indicate a duration of 6 hours and 45 minutes.

Meeting indicator 520 relates to a meeting that has a start time of 9:00 and an end time of 9:30. It can be seen that the top boundary of meeting indicator 520 corresponds with a time of 9:00 and that the bottom boundary of meeting indicator 520 corresponds with a time of 9:30. In this manner, meeting indicator 520 is sized to indicate a duration of 30 minutes. It can be seen that, at least part of, meeting indicator 520 corresponds with, at least part of, a time of meeting indicator 511 and, at least part of, a time of meeting indicator 516.

Meeting indicator 521 relates to a meeting that has a start time of 12:00 and an end time of 13:05. It can be seen that the top boundary of meeting indicator 521 corresponds with a time of 12:00 and that the bottom boundary of meeting indicator 521 corresponds with a time of 13:05. In this manner, meeting indicator 521 is sized to indicate a duration of 1 hour and 5 minutes. It can be seen that, at least part of, meeting indicator 521 corresponds with, at least part of, a time of meeting indicator 513, at least part of, a time of meeting indicator 517, and, at least part of, a time of meeting indicator 518.

Meeting indicator 522 relates to a meeting that has a start time of 17:30 and an end time of 18:00. It can be seen that the top boundary of meeting indicator 522 corresponds with a time of 17:30 and that the bottom boundary of meeting indicator 522 corresponds with a time of 18:00. In this manner, meeting indicator 522 is sized to indicate a duration of 30 minutes. It can be seen that, at least part of, meeting indicator 522 corresponds with, at least part of, a time of meeting indicator 515 and, at least part of, a time of meeting indicator 519.

Meeting indicator 523 relates to a meeting that has a start time of 20:30 and an end time of 21:00. It can be seen that the top boundary of meeting indicator 523 corresponds with a time of 20:30 and that the bottom boundary of meeting indicator 523 corresponds with a time of 21:00. In this manner, meeting indicator 523 is sized to indicate a duration of 30 minutes. It can be seen that, at least part of, meeting indicator 523 fails to correspond with, at least part of, a time of any other meeting indicator.

In the example of FIG. 5, the visual meeting path comprises visual meeting path nodes 550, 551, 552, 553, 554, 555, 556, 557, 558, and 559. It can be seen that visual meeting path node 550 corresponds with meeting indicator 516, and is at a position within the boundary of meeting indicator 515. Visual meeting path node 551 corresponds with visual meeting indicator 516, and is at a position that corresponds with a bottom boundary of meeting indicator 516. Visual meeting path node 552 corresponds with visual meeting indicator 512, and is at a position that corresponds with a top boundary of meeting indicator 512. Visual meeting path node 553 corresponds with visual meeting indicator 521, and is at a position that corresponds with a side boundary of meeting indicator 521. Visual meeting path node 554 corresponds with meeting indicator 518, and is at a position within the boundary of meeting indicator 518. Visual meeting path node 555 corresponds with meeting indicator 518, and is at a position within the boundary of meeting indicator 518. Visual meeting path node 556 corresponds with meeting indicator 519, and is at a position within the boundary of meeting indicator 519. Visual meeting path node 557 corresponds with meeting indicator 514, and is at a position within the boundary of meeting indicator 514. Visual meeting path node 558 corresponds with meeting indicator 519, and is at a position within the boundary of meeting indicator 519. Visual meeting path node 559 corresponds with meeting indicator 519, and is at a position within the boundary of meeting indicator 519.

It can be seen that visual meeting path connector 560 connects visual meeting path node 550 and visual meeting path node 551. It can be seen that visual meeting path connector 561 connects visual meeting path node 551 and visual meeting path node 552. It can be seen that visual meeting path connector 562 connects visual meeting path node 552 and visual meeting path node 553. It can be seen that visual meeting path connector 563 connects visual meeting path node 553 and visual meeting path node 554. It can be seen that visual meeting path connector 564 connects visual meeting path node 554 and visual meeting path node 555. It can be seen that visual meeting path connector 565 connects visual meeting path node 555 and visual meeting path node 556. It can be seen that visual meeting path connector 566 connects visual meeting path node 556 and visual meeting path node 557. It can be seen that visual meeting path connector 567 connects visual meeting path node 557 and visual meeting path node 558. It can be seen that visual meeting path connector 568 connects visual meeting path node 558 and visual meeting path node 559.

In some circumstances, the visual meeting path may comprise a single visual meeting path node that corresponds with the meeting indicator. For example, the single visual meeting path node may be at a position that corresponds with a boundary of the meeting indicator, at a position with the meeting indicator, and/or the like. In at least one example embodiment, the apparatus may determine an attendance status of a meeting based at least in part on a determination that the visual meeting path comprises a single visual meeting path node that corresponds with the meeting indicator. For example, it can be seen that the visual meeting path of the example of FIG. 5 comprises visual meeting path node 552, which is a single visual meeting path node that corresponds with meeting indicator 512, comprises visual meeting path node 553, which is a single visual meeting path node that corresponds with meeting indicator 521, and comprises visual meeting path node 557, which is a single visual meeting path node that corresponds with meeting indicator 514.

In at least one example embodiment, the single visual meeting path node relates to a position within a boundary of the meeting indicator. In such an example, the attendance status comprises an attendance start time that corresponds with a time indicated by a position of the single visual meeting path node. For example, visual meeting path node 557 may be at a position that corresponds with the attendance start time of the meeting associated with meeting indicator 515. In at least one example embodiment, the apparatus may determine the attendance start time of meeting 514 based, at least in part, on the position of visual meeting path node 557. In circumstances where there is a single visual meeting path node that corresponds with a meeting indicator, the apparatus may determine the attendance end time of the meeting to correlate to the meeting end time. For example, the attendance status of the meeting associated with meeting indicator 514 may indicate less than the entirety of the meeting associated with meeting indicator 514 by comprising an attendance start time that corresponds with the position of visual meeting path node 557 and an attendance end time that corresponds with the end time of the meeting

In some circumstances, the single visual meeting path node may relate to a position that corresponds with a boundary of the meeting indicator. In such circumstances, the attendance status may indicate the entirety of the meeting. For example, correspondence of visual meeting path node 552 at the top boundary of meeting indicator 513 may indicate attendance status of the entirety of the meeting associated with meeting indicator 513. In another example, correspondence of visual meeting path node 553 at the side boundary of meeting indicator 521 may indicate attendance status of the entirety of the meeting associated with meeting indicator 521.

In some circumstances, the visual meeting path may comprise a plurality of visual meeting path nodes that correspond with a meeting indicator. For example, visual meeting path nodes 550 and 551 correspond with meeting indicator 516. In another example, visual meeting path nodes 554 and 555 correspond with meeting indicator 518. In yet another example, visual meeting path nodes 556, 558, and 559 correspond with meeting indicator 519. In such circumstances, the visual meeting path node associated with the earliest time relates to the attendance start time. In such an example, the next subsequent visual meeting path node may indicate an attendance end time. For example, visual meeting path node 550 may indicate an attendance start time of the meeting of meeting indicator 516, and visual meeting path node 551 may indicate an attendance end time. In another example, visual meeting path node 554 may indicate an attendance start time of the meeting of meeting indicator 518, and visual meeting path node 555 may indicate an attendance end time. In another example, visual meeting path node 556 may indicate an attendance start time of the meeting of meeting indicator 519, and visual meeting path node 557 may indicate an attendance end time of the meeting of meeting indicator 519. For example, even though visual meeting path node 557 corresponds with meeting indicator 514, as the next subsequent visual meeting path node from visual meeting path node 556, the time associated with visual meeting path node 557 may indicate an attendance end time of the meeting of meeting indicator 519. For example, by identifying an attendance start time of another meeting, visual meeting path node 557 may also identify an attendance end time of the meeting of meeting indicator 519. In this manner, visual meeting path node 558 may identify another attendance start time of the meeting of meeting indicator 519, for example, by being subsequent to the attendance end time indicated by visual meeting path node 557. Likewise, visual meeting path node 559 may indicate another attendance end time of the meeting of meeting indicator 519.

In some circumstances, the apparatus may have already caused communication of an attendance status of a meeting to another apparatus. In such circumstances, the apparatus may determine that the visual meeting path indicates a change in attendance status of the meeting. In at least one example embodiment, the apparatus determines that the attendance status differs from a previously communicated attendance status and causes communication of the attendance status based, at least in part, on the determination that the attendance status differs from a previously communicated attendance status. In some circumstances, determination that the visual meeting path indicates attendance status of a meeting that corresponds with previously communicated attendance status, the apparatus may preclude sending of attendance status based on the visual meeting path associated with the meeting.

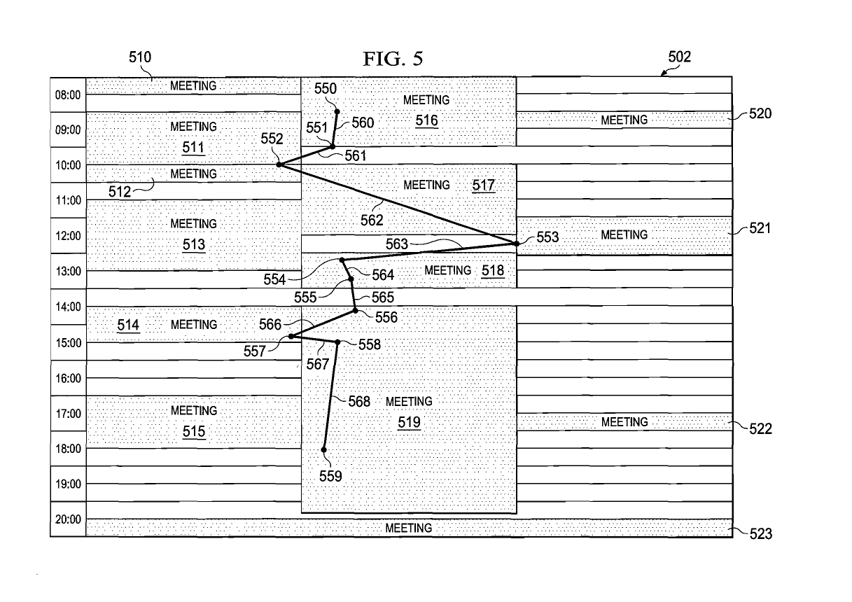

FIGS. 6A-6B are illustrations relating to input indicative of, at least part of, a visual meeting path according to at least one example embodiment. The examples of FIGURES are merely examples and do not limit the claims in any way. For example, type of input may vary, position of input may vary, orientation of information may vary, and/or the like.

There are many ways that a user may be able to provide input relating to a visual meeting path. For example, the user may provide input to establish a visual meeting path, to change a visual meeting path, to remove a visual meeting path, and/or the like. In at least one example embodiment, an apparatus allows a user to provide input that defines, at least part of, a visual meeting path. For example, the apparatus may receive an indication of a movement input, an indication of a touch input, an indication of a selection input, and/or the like, that pertain to a visual meeting path. In this manner, the apparatus may determine the visual meeting path based, at least in part, on the input.

In at least one example, embodiment, the input relates to a movement input. In at least one example embodiment, a movement input relates to a touch input received by a touch sensor, such as a touch display, a motion input received from motion sensor, such as an accelerometer, a pointer input received from a tracking sensor, such as a mouse, and/or the like. The movement input may relate to movement of a point with respect to the calendar information.

In at least one example embodiment, the movement input comprises at least one direction change. In such an example, the apparatus may determine a visual meeting path node that has a position that corresponds to the position of the movement direction change. For example, a user may provide a movement input that is similar to the visual meeting path connectors of FIG. 5. In such an example, the apparatus may determine the visual meeting path nodes based, at least in part, on movement direction changes between a movement input associated with a visual meeting path connector and a movement input associated with a subsequent visual meeting path indicator. In this manner, the user may define a position of a visual meeting path node by changing direction of the movement input.

In at least one example embodiment, the movement input comprises at least one movement pause. A movement pause may relate to a temporary cessation of movement associated with the movement input. For example, the input may indicate movement, followed by a temporary cessation of movement, followed by more movement. In at least one example embodiment, determination of the visual meeting path comprises determination of a visual meeting path node that has a position that correlates to a position of the movement pause. For example, a user may define a visual meeting path by drawing a line within a representation of calendar information. In such an example, the user may define a visual path meeting node by way of pausing movement at a position when performing the input. In this manner, the user may define the visual meeting path node to correspond with the position at which the user has paused the movement.

In at least one example embodiment, the input comprises a selection input. The selection input may relate to a tap input, such as a tap on a touch sensor, a button press input, such as a press of a mouse button, and/or the like. In at least one example embodiment, determination of the visual meeting path comprises determination of a visual meeting path node that has a position that correlates to a position of the selection input. In this manner, the user may be able to define a visual meeting path node by performing a selection input at a position to be associated with the visual meeting path node.

In at least one example embodiment, an apparatus may receive input indicative of a change in the visual meeting path. For example, the change may relate to an addition of a visual meeting path node, a removal of a visual meeting path node, a movement of a visual meeting path node, and/or the like. In at least one example embodiment, the input may indicate removal of a visual meeting path node by way of a selection input that corresponds with the visual meeting path node, by indicating movement of the visual meeting path node to a position that corresponds with another meeting path node, and/or the like.

In at least one example embodiment, addition of a visual meeting path node relates to movement of a visual meeting path connector such that the connector comprises a direction change. In such an example, the apparatus may determine existence of a visual meeting path node at the position of the direction change. An example of such input is illustrated in the example of FIGS. 6A-6B. FIG. 6A illustrates a visual meeting path comprising visual meeting path connector 605, which connects visual meeting path nodes 601 and 602. In the example of FIG. 6A, the apparatus receives movement input 610 which relates to a movement of a part of visual meeting path connector 605 at a position between visual meeting path nodes 601 and 602. FIG. 6B illustrates a changed visual meeting path that may result from movement input 610. In the example of FIG. 6B, the apparatus has added visual meeting path node 603 at a position that corresponds with a direction change of connector 605 after the connector is moved. In this manner, the introduction of visual meeting path node 603 replaces visual meeting path connector 605 with visual meeting path connectors 606 and 607. In this manner, there is no longer a visual meeting path connector that directly connects visual meeting path nodes 601 and 602. It can be seen that visual meeting path connector 606 connects visual meeting path nodes 601 and 603. It can also be seen that visual meeting path connector 607 connects visual meeting nodes 603 and 602.

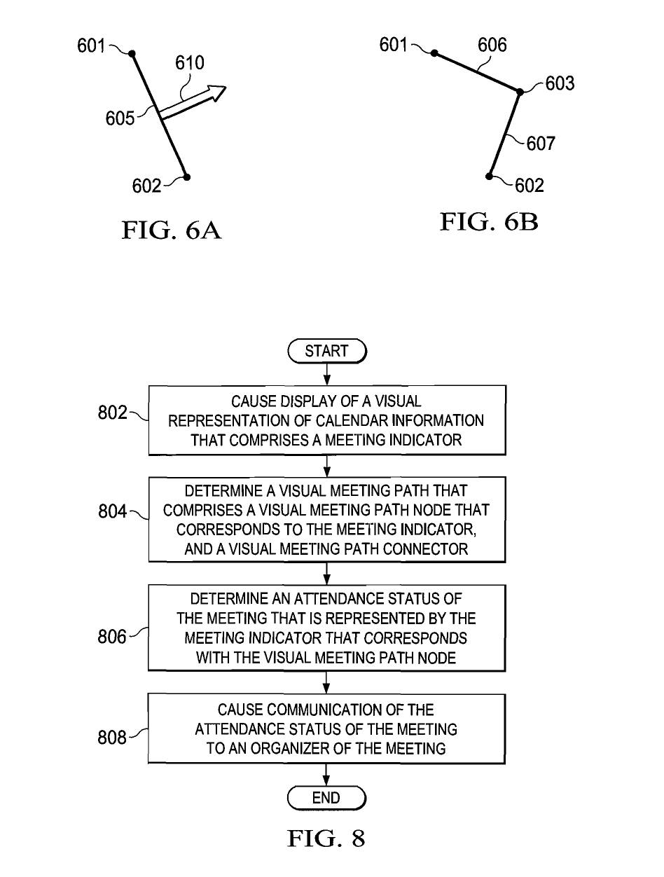

FIG. 7 is an illustration relating to a visual representation of meeting invitee attendance status according to at least one example embodiment. The example of FIG. 7 is merely an example and does not limit the claims in any way. For example, orientation of visual information may vary, representation of information may vary, the format may vary, arrangement of information may vary, and/or the like.

In some circumstances, it may be desirable for a meeting organizer to be able to view a visual representation of the attendance status of meeting invitees. For example, it may be desirable to allow the meeting organizer to quickly and intuitively view a visual representation of the attendance status of the meeting invitees without necessarily reading text indicative of the attendance status of each individual meeting invitee.

In at least one example embodiment, the apparatus causes display of a visual representation of attendance status of the meeting. In at least one example embodiment, attendance status of the meeting relates to attendance status of a plurality of meeting invitees associated with the meeting. The attendance status of the invitee may relate to attendance status received similarly as described regarding FIGS. 3A-3C.

In at least one example embodiment, the visual representation of the attendance status of the meeting relates to a visual representation that indicates time along an axis and indicates varying meeting invitees along a different axis. For example, the visual representation of the attendance status of the meeting may indicate time along a horizontal axis and may indicate different meeting attendees along a vertical axis.

In at least one example embodiment, the visual representation of the attendance status of the meeting comprises at least one attendance indicator that indicates the attendance status of the meeting relating to a particular meeting invitee. The attendance status indicator may relate to a shape having a boundary that indicates attendance start time an attendance end time of the meeting invitee, and/or the like. For example, the attendance status indicator may comprise a boundary that indicates an attendance start time and an opposite boundary that indicates an attendance end time. In at least one example embodiment, the visual representation of the attendance status of the meeting comprises a meeting indicator. The meeting indicator may be similar as described regarding FIGS. 4A-4B, FIG. 5, and/or the like. In at least one example, embodiment, the visual representation of the attendance status of the meeting relates to the attendance status indicator overlaying the meeting indicator.

The example of FIG. 7 illustrates visual representation 702 of attendance status of a meeting indicated by meeting indicator 704. It can be seen that the meeting start time is 17:00 and the meeting end time is 18:30. In the example of FIG. 7, meeting invitees are arranged along a vertical axis. Attendance status indicator 721 relates to meeting invitee 711, attendance status indicator 722 relates to meeting invitee 712, attendance status indicator 723 relates to meeting invitee 713, attendance status indicator 724 relates to meeting invitee 714, attendance status indicator 725 relates to meeting invitee 715, and attendance status indicator 726 relates to meeting invitee 716. It can be seen that attendance status indicator 721 indicates the entirety of the meeting, attendance status 722 indicates an attendance start time of 17:30 and an attendance end time of 18:30, attendance status indicators 723 and 725 indicate absence from the meeting, attendance status indicator 724 indicates an attendance start time of 17:30 and an attendance end time of 18:15, and attendance status indicator 726 indicates an attendance start time of 18:00 and an attendance end time of 18:30.

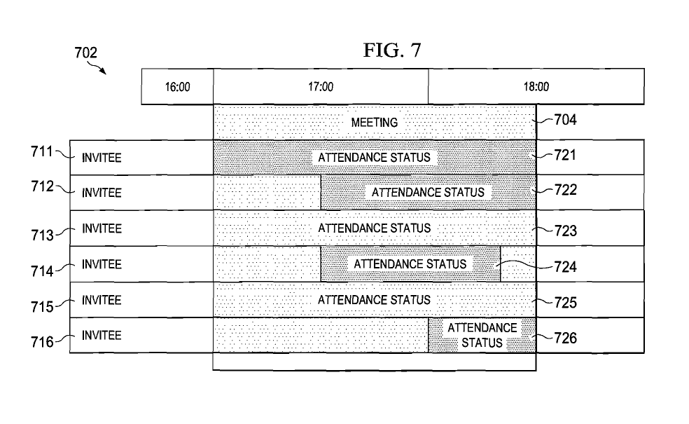

FIG. 8 is a flow diagram illustrating activities associated with a visual meeting path according to at least one example embodiment. In at least one example embodiment, there is a set of operations that corresponds to the activities of FIG. 8. An apparatus, for example MCS/MCC 44 of FIG. 1 and FIG. 2, or a portion thereof, may utilize the set of operations. The apparatus may comprise means, including, for example processor 84f of FIG. 2, for performing such operations. In an example embodiment, an apparatus, for example MCS/MCC 44 of FIG. 1 and FIG. 2, is transformed by having memory, for example memory element 86f of FIG. 2, comprising computer code configured to, working with a processor, for example processor 84f of FIG. 2, cause the apparatus to perform set of operations of FIG. 8.

At block 802, the apparatus causes display of a visual representation of calendar information that comprises at least one meeting indicator. The causation of display, the visual representation of the calendar information and the meeting indicator may be similar as described regarding FIGS. 4A-4B. In at least one example embodiment, the meeting indicator is positioned at a location that corresponds to a time of a meeting represented by the meeting indicator and is sized to correspond with a duration of the meeting.

At block 804, the apparatus determines a visual meeting path that comprises at least one visual meeting path node that corresponds to the meeting indicator, and at least one visual meeting path connector that visually connects to the visual meeting path node. The determination, the visual meeting path, the visual meeting path node, and the visual meeting path connector may be similar as described regarding FIG. 5.

At block 806, the apparatus determines an attendance status of the meeting, such that the attendance status corresponds with the visual meeting path node. The determination and the attendance status of the meeting may be similar as described regarding FIGS. 3A-3C, FIGURES, and/or the like.

At block 808, the apparatus causes communication of the attendance status of the meeting to an organizer of the meeting. The causation of communication and the organizer of the meeting may be similar as described regarding FIGS. 3A-3C.

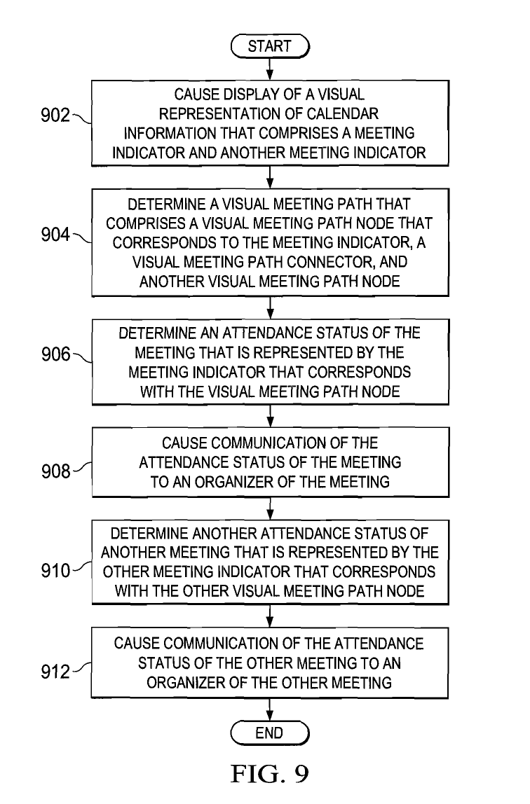

FIG. 9 is a flow diagram illustrating activities associated with a visual meeting path according to at least one example embodiment. In at least one example embodiment, there is a set of operations that corresponds to the activities of FIG. 9. An apparatus, for example MCS/MCC 44 of FIG. 1 and FIG. 2, or a portion thereof, may utilize the set of operations. The apparatus may comprise means, including, for example processor 84f of FIG. 2, for performing such operations. In an example embodiment, an apparatus, for example MCS/MCC 44 of FIG. 1 and FIG. 2, is transformed by having memory, for example memory element 86f of FIG. 2, comprising computer code configured to, working with a processor, for example processor 84f of FIG. 2, cause the apparatus to perform set of operations of FIG. 9.

As previously described, in some circumstances, the representation of the calendar information may comprise a plurality of meeting indicators. For example, the representation of the calendar information may comprise a meeting indicator and another meeting indicator, such that the visual meeting path comprises at least one visual meeting path node that corresponds with the meeting indicator and another visual meeting path node that corresponds with the other meeting indicator.

At block 902, the apparatus causes display of a visual representation of calendar information that comprises at least one meeting indicator and another meeting indicator. The causation of display, the visual representation of the calendar information, the meeting indicator, and the other meeting indicator may be similar as described regarding FIGS. 4A-4B. In at least one example embodiment, the meeting indicator is positioned at a location that corresponds to a time of a meeting represented by the meeting indicator and is sized to correspond with a duration of the meeting. In at least one example embodiment, the other meeting indicator is positioned at a location that corresponds to a time of another meeting represented by the other meeting indicator and is sized to correspond with a duration of the other meeting.

At block 904, the apparatus determines a visual meeting path that comprises at least one visual meeting path node that corresponds to the meeting indicator, and at least one visual meeting path connector that visually connects to the visual meeting path node with another visual meeting path node. The determination, the visual meeting path, the visual meeting path node, the other visual meeting path node, and the visual meeting path connector may be similar as described regarding FIG. 5.

At block 906, the apparatus determines an attendance status of the meeting, such that the attendance status corresponds with the visual meeting path node. The determination and the attendance status of the meeting may be similar as described regarding FIGS. 3A-3C, FIGURES, and/or the like.

At block 908, the apparatus causes communication of the attendance status of the meeting to an organizer of the meeting. The causation of communication and the organizer of the meeting may be similar as described regarding FIGS. 3A-3C.

At block 910, the apparatus determines another attendance status of the other meeting that is represented by the other meeting indicator that corresponds with the other visual meeting path node. The determination and the other attendance status of the other meeting may be similar as described regarding FIGS. 3A-3C, FIGURES, and/or the like.

At block 912, the apparatus causes communication of the other attendance status of the other meeting to an organizer of the other meeting. The causation of communication and the organizer of the other meeting may be similar as described regarding FIGS. 3A-3C.

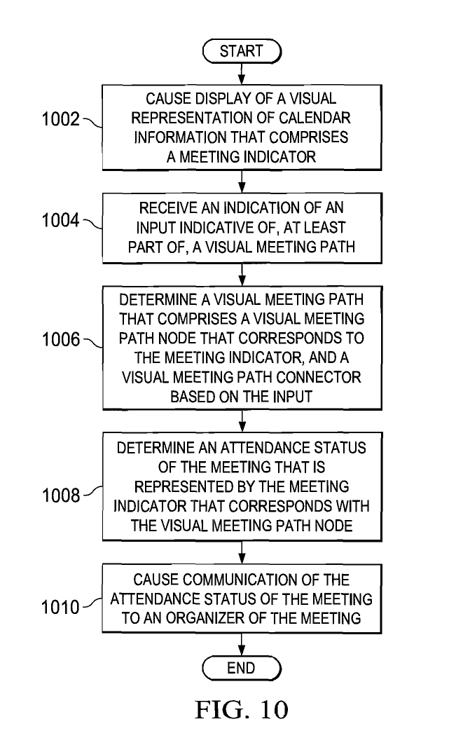

FIG. 10 is a flow diagram illustrating activities associated with a visual meeting path according to at least one example embodiment. In at least one example embodiment, there is a set of operations that corresponds to the activities of FIG. 10. An apparatus, for example MCS/MCC 44 of FIG. 1 and FIG. 2, or a portion thereof, may utilize the set of operations. The apparatus may comprise means, including, for example processor 84f of FIG. 2, for performing such operations. In an example embodiment, an apparatus, for example MCS/MCC 44 of FIG. 1 and FIG. 2, is transformed by having memory, for example memory element 86f of FIG. 2, comprising computer code configured to, working with a processor, for example processor 84f of FIG. 2, cause the apparatus to perform set of operations of FIG. 10.

As previously described, in some circumstances, the apparatus may base a visual meeting path on input indicative of the visual meeting path.

At block 1002, the apparatus causes display of a visual representation of calendar information that comprises at least one meeting indicator, similarly as described regarding block 802 of FIG. 8.

At block 1004, the apparatus receives an indication of an input indicative of, at least part of, the visual meeting path. The receipt and the input may be similar as described regarding FIGS. 6A-6B.

At block 1006, the apparatus determines a visual meeting path based, at least in part, on the input, such that the visual meeting path comprises at least one visual meeting path node that corresponds to the meeting indicator, and at least one visual meeting path connector that visually connects to the visual meeting path node. The determination, the visual meeting path, the visual meeting path node, and the visual meeting path connector may be similar as described regarding FIG. 5, FIGS. 6A-6B, and/or the like.

At block 1008, the apparatus determines an attendance status of the meeting, such that the attendance status corresponds with the visual meeting path node, similarly as described regarding block 806 of FIG. 8.

At block 1010, the apparatus causes communication of the attendance status of the meeting to an organizer of the meeting, similarly as described regarding block 808 of FIG. 8.

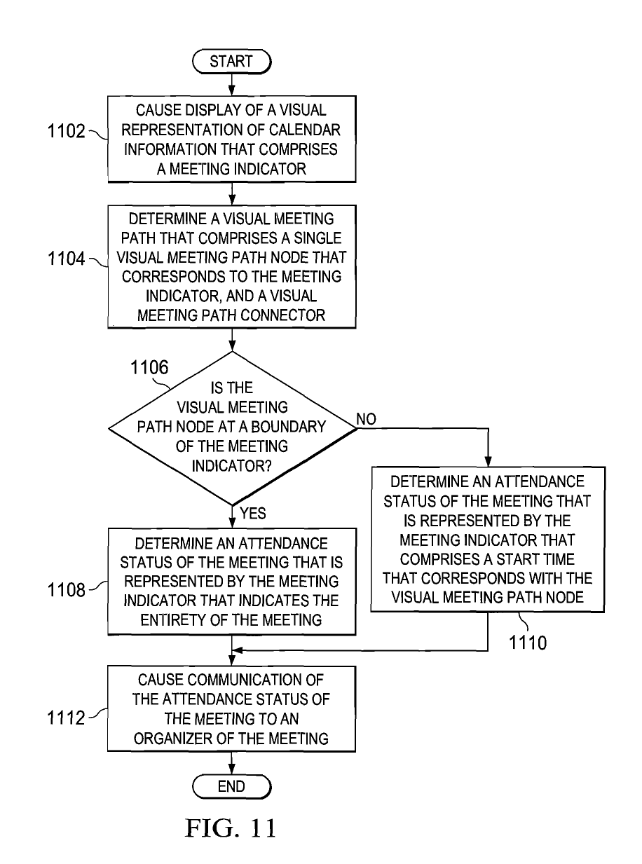

FIG. 11 is a flow diagram illustrating activities associated with a visual meeting path according to at least one example embodiment. In at least one example embodiment, there is a set of operations that corresponds to the activities of FIG. 11. An apparatus, for example MCS/MCC 44 of FIG. 1 and FIG. 2, or a portion thereof, may utilize the set of operations. The apparatus may comprise means, including, for example processor 84f of FIG. 2, for performing such operations. In an example embodiment, an apparatus, for example MCS/MCC 44 of FIG. 1 and FIG. 2, is transformed by having memory, for example memory element 86f of FIG. 2, comprising computer code configured to, working with a processor, for example processor 84f of FIG. 2, cause the apparatus to perform set of operations of FIG. 11.

At block 1102, the apparatus causes display of a visual representation of calendar information that comprises at least one meeting indicator, similarly as described regarding block 802 of FIG. 8.

At block 1104, the apparatus determines a visual meeting path that comprises a single visual meeting path node that corresponds to the meeting indicator, and at least one visual meeting path connector that visually connects to the visual meeting path node. The determination, the visual meeting path, the visual meeting path node, and the visual meeting path connector may be similar as described regarding FIG. 5, FIGS. 6A-6B, and/or the like.

At block 1106, the apparatus determines whether the visual meeting path node is at a boundary of the meeting indicator. If the apparatus determines that the visual meeting path node corresponds with a boundary of the meeting indicator, flow proceeds to block 1108. If the apparatus determines that the visual meeting path node fails to correspond with a boundary of the meeting indicator, flow proceeds to block 1110.

At block 1108, the apparatus determines an attendance status of the meeting that indicates the entirety of the meeting. In this manner, the apparatus may determine an attendance status indicative of the entirety of the meeting based, at least in part, on the visual meeting path node corresponding to the boundary of the meeting indicator. Flow may proceed to block 1112.

At block 1110, the apparatus determines an attendance status of the meeting that comprises an attendance start time that corresponds with a time indicated by a position of the visual meeting path node. In this manner, the apparatus may determine the attendance start time that corresponds with the time indicated by the position of the visual meeting path node based, at least in part, on the position being within the boundary of the meeting indicator.

At block 1112, the apparatus causes communication of the attendance status of the meeting to an organizer of the meeting, similarly as described regarding block 808 of FIG. 8.

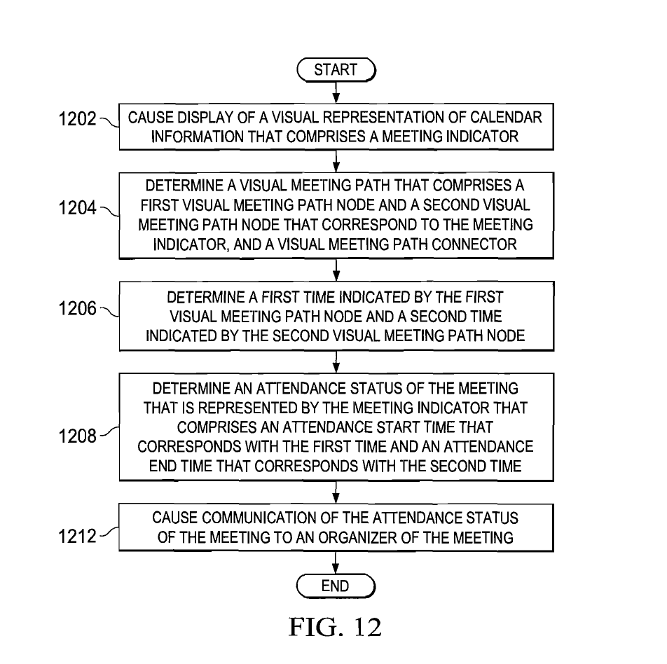

FIG. 12 is a flow diagram illustrating activities associated with a visual meeting path according to at least one example embodiment. In at least one example embodiment, there is a set of operations that corresponds to the activities of FIG. 12. An apparatus, for example MCS/MCC 44 of FIG. 1 and FIG. 2, or a portion thereof, may utilize the set of operations. The apparatus may comprise means, including, for example processor 84f of FIG. 2, for performing such operations. In an example embodiment, an apparatus, for example MCS/MCC 44 of FIG. 1 and FIG. 2, is transformed by having memory, for example memory element 86f of FIG. 2, comprising computer code configured to, working with a processor, for example processor 84f of FIG. 2, cause the apparatus to perform set of operations of FIG. 12.

At block 1202, the apparatus causes display of a visual representation of calendar information that comprises at least one meeting indicator, similarly as described regarding block 802 of FIG. 8.

At block 1204, the apparatus determines a visual meeting path that comprises a first visual meeting path node and a second visual meeting path node that correspond to the meeting indicator, and at least one visual meeting path connector that visually connects the first visual meeting path node and the second visual meeting path node. The determination, the visual meeting path, the first visual meeting path node, the second visual meeting path node, and the visual meeting path connector may be similar as described regarding FIG. 5.

At block 1206, the apparatus determines a first time indicated by a position of the first visual meeting path node and a second time indicated by a position of the second visual meeting path node.

At block 1208, the apparatus determines an attendance status of the meeting, such that the attendance status comprises an attendance start time that corresponds with the first time and an attendance end time that corresponds with the second time. The determination, the attendance start time, and the attendance end time may be similar as described regarding FIGS. 3A-3C, FIGURES, and/or the like.

At block 1212, the apparatus causes communication of the attendance status of the meeting to an organizer of the meeting, similarly as described regarding block 808 of FIG. 8.

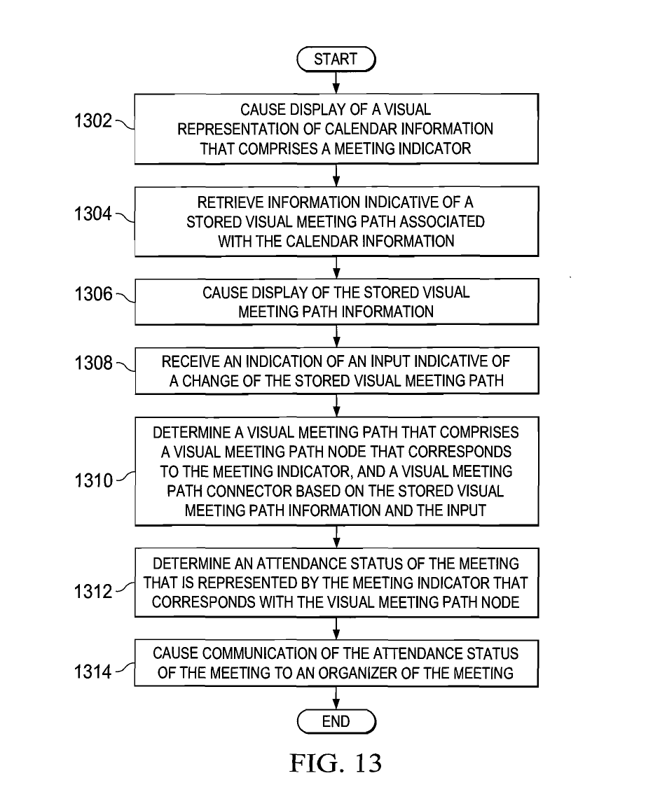

FIG. 13 is a flow diagram illustrating activities associated with a visual meeting path according to at least one example embodiment. In at least one example embodiment, there is a set of operations that corresponds to the activities of FIG. 13. An apparatus, for example MCS/MCC 44 of FIG. 1 and FIG. 2, or a portion thereof, may utilize the set of operations. The apparatus may comprise means, including, for example processor 84f of FIG. 2, for performing such operations. In an example embodiment, an apparatus, for example MCS/MCC 44 of FIG. 1 and FIG. 2, is transformed by having memory, for example memory element 86f of FIG. 2, comprising computer code configured to, working with a processor, for example processor 84f of FIG. 2, cause the apparatus to perform set of operations of FIG. 13.

In at least one example embodiment, information indicative of a visual meeting path may be stored for later retrieval. For example, the apparatus may comprise memory in which the information indicative of the visual meeting path is stored. In another example, a calendar server may comprise memory in which the information indicative of the visual meeting path is stored, and the apparatus may retrieve the information indicative of the visual meeting path from the calendar server. In at least one example embodiment, information indicative of the visual meeting path relates to information that may be utilized to represent the visual meeting path, to construct the visual meeting path, and/or the like. For example, the information indicative of the visual meeting path may relate to attendance status of the meetings represented by the calendar information. As previously described, the apparatus may cause display of a visual meeting path based, at least in part, on the stored visual meeting path information. In such an example, the user may desire to change the visual meeting path to cause determination of a changed visual meeting path that is based, at least in part, on the stored visual meeting path information and input from the user.

At block 1302, the apparatus causes display of a visual representation of calendar information that comprises at least one meeting indicator, similarly as described regarding block 802 of FIG. 8.

At block 1304, the apparatus retrieves information indicative of a stored visual meeting path associated with the calendar information. At block 1306, the apparatus causes display of the stored visual meeting path information. The causation of display may be similar as described regarding FIG. 5.

At block 1308, the apparatus receives an indication of an input indicative of a change of, at least part of, the stored visual meeting path. The input may be similar as described regarding FIGS. 6A-6B.

At block 1310, the apparatus determines a visual meeting path based, at least in part, on the stored visual meeting path information and the input, such that the visual meeting path comprises at least one visual meeting path node that corresponds to the meeting indicator, and at least one visual meeting path connector that visually connects to the visual meeting path node. The determination, the visual meeting path, the visual meeting path node, and the visual meeting path connector may be similar as described regarding FIG. 5, FIGS. 6A-6B, and/or the like.

At block 1312, the apparatus determines an attendance status of the meeting, such that the attendance status corresponds with the visual meeting path node, similarly as described regarding block 806 of FIG. 8.

At block 1314, the apparatus causes communication of the attendance status of the meeting to an organizer of the meeting, similarly as described regarding block 808 of FIG. 8.

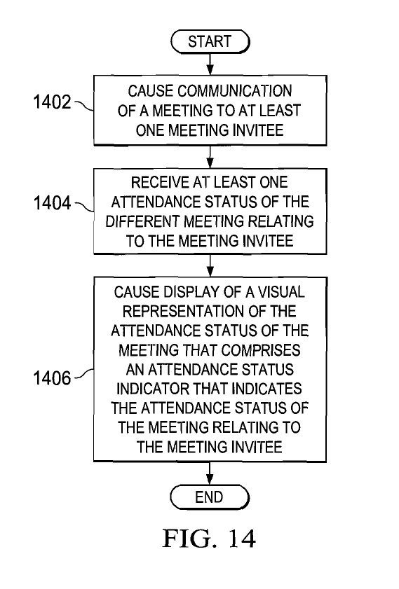

FIG. 14 is a flow diagram illustrating activities associated with visual representation of meeting invitee attendance status according to at least one example embodiment. In at least one example embodiment, there is a set of operations that corresponds to the activities of FIG. 14. An apparatus, for example MCS/MCC 44 of FIG. 1 and FIG. 2, or a portion thereof, may utilize the set of operations. The apparatus may comprise means, including, for example processor 84f of FIG. 2, for performing such operations. In an example embodiment, an apparatus, for example MCS/MCC 44 of FIG. 1 and FIG. 2, is transformed by having memory, for example memory element 86f of FIG. 2, comprising computer code configured to, working with a processor, for example processor 84f of FIG. 2, cause the apparatus to perform set of operations of FIG. 14. It should be understood that, even though the operations of FIG. 14 are discussed separately from the operations of FIGS. 8-13, the operations of FIG. 14 may be combined with any of the operations of FIGS. 8-13.

At block 1402, the apparatus causes communication of a meeting to at least one meeting invitee. The causation of communication and the meeting invitee may be similar as described regarding FIGS. 3A-3C.

At block 1404, the apparatus receives at least one attendance status of the meeting relating to the meeting invitee. The attendance status may be similar as described regarding FIGS. 3A-3C, FIG. 5, and/or the like.

At block 1406, the apparatus causes display of a visual representation of the attendance status of the meeting that comprises an attendance status indicator that indicates the attendance status of the different meeting relating to the meeting invitee. The causation of display, the visual representation of the attendance status of the meeting, and the attendance status indicator may be similar as described regarding FIG. 7.

Note that with the examples provided herein, interaction may be described in terms of two or three elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and may accommodate a large number of rooms and sites, as well as more complicated/sophisticated arrangements and configurations. Accordingly, the examples provided herein should not limit the scope or inhibit the broad teachings of communication system 10 as potentially applied to a myriad of other architectures. Additionally, although described with reference to particular scenarios where MCSs/MCC 44 resides in a particular physical location, MCSs/MCC 44 may reside in any location, provided it has some connectivity to a suitable network.

It is also important to note that the steps discussed with reference to FIGS. 1-9 illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular embodiments, it should be understood that various other changes, substitutions, and alterations may be made hereto without departing from the spirit and scope of the present disclosure. For example, although the present disclosure has been described as operating in WebEx and Meeting Place conferencing environments or arrangements, the present disclosure may be used in any online environment that could benefit from such technology. For example, in certain instances, computers that are coupled to each other in some fashion may utilize the teachings of the present disclosure (e.g., even though participants would be in a face-to-face arrangement). Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A method, comprising:
causing display of a visual representation of calendar information that comprises at least one meeting indicator, the meeting indicator being positioned at a location that corresponds to a time of a meeting represented by the meeting indicator and being sized to correspond with a duration of the meeting;
determining a visual meeting path that comprises at least one visual meeting path node that corresponds to the meeting indicator, and at least one visual meeting path connector that visually connects to the visual meeting path node;
determining an attendance status of the meeting, such that the attendance status corresponds with the visual meeting path node; and
causing communication of the attendance status of the meeting to an organizer of the meeting.

2. The method of claim 1, further comprising:
causation of communication of a different meeting to at least one meeting invitee;
receipt of at least one attendance status of the different meeting relating to the meeting invitee;
causation of display of a visual representation of the attendance status of the meeting that comprises an attendance status indicator that indicates the attendance status of the different meeting relating to the meeting invitee by a boundary of the attendance status indicator corresponding to a position that indicates an attendance start time of the attendance status of the different meeting relating to the meeting invitee and an opposite boundary of the attendance status indicator corresponding to a position that indicates an attendance end time of the attendance status of the different meeting relating to the meeting invitee.

3. The method of claim 1, further comprising receipt of an indication of an input indicative of, at least part of, the visual meeting path, wherein determination of the visual meeting path is based, at least in part, on the input.

4. The method of claim 1, wherein the visual meeting path comprises a single visual meeting path node that corresponds with the meeting indicator.

5. The method of claim 4, wherein the single visual meeting path node relates to a position within a boundary of the meeting indicator, and the attendance status comprises an attendance start time that corresponds with a time indicated by a position of the single visual meeting path node.

6. The method of claim 4, wherein the single visual meeting path node relates to a position that corresponds with a boundary of the meeting indicator, and the attendance status indicates the entirety of the meeting.

7. The method of claim 1, wherein the visual meeting path comprises a first visual meeting path node that corresponds with the meeting indicator and a second first visual meeting path node that corresponds with the meeting indicator, and the first visual meeting path node relates to a first position associated with a first time and the second visual meeting path node relates to a second position associated with a second time, such that the first time is a time before the second time, and the attendance status comprises an attendance start time that corresponds with the first time and an attendance end time that corresponds with the second time.

8. The method of claim 1, further comprising:
retrieval of information indicative of a stored visual meeting path associated with the calendar information;
causation of display of the stored visual meeting path information; and
receipt of an indication of an input indicative of a change of, at least part of, the stored visual meeting path, wherein determination of the visual meeting path is based, at least in part, on the stored visual meeting path and the input.

9. An apparatus comprising at least one processor and at least one memory, the at least one memory including computer program instructions that, when executed by the at least one processor, cause the apparatus to:
cause display of a visual representation of calendar information that comprises at least one meeting indicator, the meeting indicator being positioned at a location that corresponds to a time of a meeting represented by the meeting indicator and being sized to correspond with a duration of the meeting;
determine a visual meeting path that comprises at least one visual meeting path node that corresponds to the meeting indicator, and at least one visual meeting path connector that visually connects to the visual meeting path node;
determine an attendance status of the meeting, such that the attendance status corresponds with the visual meeting path node; and
cause communication of the attendance status of the meeting to an organizer of the meeting.

10. The apparatus of claim 9, wherein the memory further includes computer program instructions that, when executed by the at least one processor, cause the apparatus to perform:
causation of communication of a different meeting to at least one meeting invitee;
receipt of at least one attendance status of the different meeting relating to the meeting invitee;
causation of display of a visual representation of the attendance status of the meeting that comprises an attendance status indicator that indicates the attendance status of the different meeting relating to the meeting invitee by a boundary of the attendance status indicator corresponding to a position that indicates an attendance start time of the attendance status of the different meeting relating to the meeting invitee and an opposite boundary of the attendance status indicator corresponding to a position that indicates an attendance end time of the attendance status of the different meeting relating to the meeting invitee.

11. The apparatus of claim 9, wherein the memory further includes computer program instructions that, when executed by the at least one processor, cause the apparatus to perform receipt of an indication of an input indicative of, at least part of, the visual meeting path, wherein determination of the visual meeting path is based, at least in part, on the input.

12. The apparatus of claim 9, wherein the visual meeting path comprises a single visual meeting path node that corresponds with the meeting indicator.

13. The apparatus of claim 12, wherein the single visual meeting path node relates to a position within a boundary of the meeting indicator, and the attendance status comprises an attendance start time that corresponds with a time indicated by a position of the single visual meeting path node.

14. The apparatus of claim 12, wherein the single visual meeting path node relates to a position that corresponds with a boundary of the meeting indicator, and the attendance status indicates the entirety of the meeting.

15. The apparatus of claim 9, wherein the visual meeting path comprises a first visual meeting path node that corresponds with the meeting indicator and a second first visual meeting path node that corresponds with the meeting indicator, and the first visual meeting path node relates to a first position associated with a first time and the second visual meeting path node relates to a second position associated with a second time, such that the first time is a time before the second time, and the attendance status comprises an attendance start time that corresponds with the first time and an attendance end time that corresponds with the second time.

16. The apparatus of claim 9, wherein the memory further includes computer program instructions that, when executed by the at least one processor, cause the apparatus to perform:
retrieval of information indicative of a stored visual meeting path associated with the calendar information;
causation of display of the stored visual meeting path information; and
receipt of an indication of an input indicative of a change of, at least part of, the stored visual meeting path, wherein determination of the visual meeting path is based, at least in part, on the stored visual meeting path and the input.

17. The apparatus of claim 9, wherein the representation of the calendar information comprises another meeting indicator, and the visual meeting path comprises at least one other visual meeting path node that corresponds with the other meeting indicator, and wherein the memory further includes computer program instructions that, when executed by the at least one processor, cause the apparatus to perform:
determination of another attendance status of another meeting that is represented by the other meeting indicator that corresponds with the other visual meeting path node; and
causation of communication of the other attendance status of the meeting to the organizer of the meeting.

18. A non-transitory computer readable medium comprising instructions that, when executed, cause an apparatus to:
cause display of a visual representation of calendar information that comprises at least one meeting indicator, the meeting indicator being positioned at a location that corresponds to a time of a meeting represented by the meeting indicator and being sized to correspond with a duration of the meeting;
determine a visual meeting path that comprises at least one visual meeting path node that corresponds to the meeting indicator, and at least one visual meeting path connector that visually connects to the visual meeting path node;
determine an attendance status of the meeting, such that the attendance status corresponds with the visual meeting path node; and
cause communication of the attendance status of the meeting to an organizer of the meeting.

19. The medium of claim 18, further comprising:
causation of communication of a different meeting to at least one meeting invitee;
receipt of at least one attendance status of the different meeting relating to the meeting invitee;
causation of display of a visual representation of the attendance status of the meeting that comprises an attendance status indicator that indicates the attendance status of the different meeting relating to the meeting invitee by a boundary of the attendance status indicator corresponding to a position that indicates an attendance start time of the attendance status of the different meeting relating to the meeting invitee and an opposite boundary of the attendance status indicator corresponding to a position that indicates an attendance end time of the attendance status of the different meeting relating to the meeting invitee.

20. The medium of claim 18, wherein the instructions further cause the apparatus to perform receipt of an indication of an input indicative of, at least part of, the visual meeting path, wherein determination of the visual meeting path is based, at least in part, on the input.

21. The medium of claim 18, wherein the visual meeting path comprises a single visual meeting path node that corresponds with the meeting indicator.

22. The medium of claim 21, wherein the single visual meeting path node relates to a position within a boundary of the meeting indicator, and the attendance status comprises an attendance start time that corresponds with a time indicated by a position of the single visual meeting path node.

23. The medium of claim 21, wherein the single visual meeting path node relates to a position that corresponds with a boundary of the meeting indicator, and the attendance status indicates the entirety of the meeting.

24. The medium of claim 18, wherein the visual meeting path comprises a first visual meeting path node that corresponds with the meeting indicator and a second first visual meeting path node that corresponds with the meeting indicator, and the first visual meeting path node relates to a first position associated with a first time and the second visual meeting path node relates to a second position associated with a second time, such that the first time is a time before the second time, and the attendance status comprises an attendance start time that corresponds with the first time and an attendance end time that corresponds with the second time.

25. The medium of claim 18, wherein the instructions further cause the apparatus to perform:
retrieval of information indicative of a stored visual meeting path associated with the calendar information;
causation of display of the stored visual meeting path information; and
receipt of an indication of an input indicative of a change of, at least part of, the stored visual meeting path, wherein determination of the visual meeting path is based, at least in part, on the stored visual meeting path and the input.
